(19) United States
(12) Patent Application Publication
(10) Pub. No.: US 2014/0304512 A1
(43) Pub. Date: Oct. 9, 2014

(54) METHOD AND SYSTEM FOR AUTHENTICATING AND PRESERVING DATA WITHIN A SECURE DATA REPOSITORY

(71) Applicants: Sergei Pronin, Voronezh (RU); Charles Holden, Brooklyn, NY (US); Andrei Kotov, The Hague (NL); OnLock B.V., The Hague (NL)

(72) Inventors: Andrei Kotov, The Hague (NL); Sergei Pronin, Voronezh (RU); Charles Holden, Brooklyn, NY (US)

(21) Appl. No.: 14/214,506

(22) Filed: Mar. 14, 2014

Related U.S. Application Data
(60) Provisional application No. 61/851,975, filed on Mar. 14, 2013.

(30) Foreign Application Priority Data
Mar. 14, 2013 (NL) NL2010454

(51) Int. Cl. H04L 9/14; H04L 29/06

(52) U.S. Cl. CPC H04L 9/14; H04L 63/0428; H04L 2209/24
USPC 713/171

(57) ABSTRACT

A computer implemented method for identifying and linking a data originator and a data file or data batch from the originator through one or more data source systems. The system stores the data files and batches on a permanent basis for subsequent verification purposes, verifying the identity of the data file originator through originator-specific information from the data source system; and generating unique data entries associated with the originator identity, the file identity and/or a file verification cryptographic digest, and a unique originator signature. The data entries and signature are stored in encrypted form in a Relay Access Table (RAT), as are the public and private keys associated with both the data file and the originator. A certificate for verification of the data file is generated, that contains a digital signature, as well as a file cryptographic digest and metadata associated with filing conditions.

### CROSS REFERENCE

The present application is filed as a continuation-in-part of U.S. Provisional Application No. 61/851,975, entitled “Method and System for Authenticating and Preserving Data Within a Secure Data Repository” filed Mar. 14, 2013 by Andrei Kotov et al and claiming priority to Netherlands Patent Application Serial No. NL2010454, entitled “A Method and System for Authenticating and Preserving Data Within a Secure Data Repository” filed Mar. 14, 2013 by OnLock B. V. and Andrei Kotov et al. Each of the above-noted documents is hereby incorporated by reference in their entirety.

### FIELD OF INVENTION

The present invention relates to a method and a system for the secure creation of a secure data repository. It more particularly concerns a process and systems allowing the origination, and verification of users, and the compilation and legally authentication of data objects that are stored encrypted in the repository, including, for example, those relating to events in the life of a data originator.

### BACKGROUND OF THE INVENTION

The use of note-taking software and the creation of data repositories through such software have become widespread in recent years. These data repositories are usually a combination of software and storage service that allow originator users to collect, sort, tag and annotate notes and other miscellaneous information. Typically, data records such as business and consumer data are contained in databases and other forms of data repositories governed by file-system structure. The information contained in such data repositories is usually continually changing. For example, account balances change, individuals change names and businesses expand and add locations, are acquired or divested.

WO2007084758 discloses a digital data archiving system and a method of enabling the secure archiving and retrieval of digital data subject to access management and auditing controls.

US2006031201 discloses a memory device and a method for obtaining and storing information relating to a life moment, by appending metadata to information coupled with a life moment, and storing the information and metadata in a secure location.

WO2008005640 discloses an assembly, apparatus, and an associated methodology for facilitating mass storage, and use, of data, such as data collected, operated upon, and used in conformity with a compliance standard that sets forth rules pertaining to access to and use of data.

US2004243539 discloses a system, method and software for providing consistent and persistent business entity identification and linking business entity information in an integrated data repository.

CN-A-201152985 discloses an electronic evidence notarizing system framework which is formed by interconnecting an electronic evidence notarizing server, a client computer and a standard time server of the national time service center through the internet.

WO-A-02/48843 discloses a web-based method and system for applying a legally enforceable signature of a user on an electronic document.

WO-A-2008/070335 discloses a notary document processing system and methods are described. The system receives files uploaded by users or files generated from user-inputted messages or annotations, processes them by applying a document ID, time stamp, etc. to pages of the document, and converts them to a read only format for storage. Once the documents are processed and stored in the system, they cannot be changed by any user including the owner of the document. The system makes stored documents available to the owner or other users upon the owner's request or permission.

WO-A-02/41163 discloses an authentication service, and more particularly to an authentication service method and system which digitalizes a document, a motion picture, a voice, and so on to be stored in a database of an authentication service server in order to use them as supporting evidences when a conflict occurs.

US 2010/0161993 discloses a notary document processing system and related methods.

US 2007/0026507 discloses a method and a system for depositing digital works and a corresponding computer program and a corresponding computer-readable storage medium.

A disadvantage of the above described methods is that the data contained in the memory or storage location is generally not static, and the systems are mainly concerned with access rights to the information, and/or prevention of accidental elimination. A further disadvantage of the above described methods is lack of user-friendliness, in that the key typically is a lengthy sequence of letters and ciphers, which makes their management by the originator difficult and cumbersome, and can lead to compromising the key itself by various means, such as the use of key logger software.

Furthermore, the security of a user computer and the network connection between the originator and the authenticating server typically represent the greatest security risk, since these are typically not encrypted or not well encrypted or otherwise protected, and hence subject to attacks such as Trojan malware or viruses or other similarly security compromising approaches.

Yet further, in the scenario where the originator's public and private key should be compromised, the confidentiality of the entire application might be compromised. This can entail not only loss of confidentiality of sensitive materials but also the loss of legal standing of said materials, in that the materials in the repository may no longer satisfy the legal requirements for at least some of its applications.

In the process disclosed in WO-A-2008/070335, there is limitation on possibility to save all types of data where primary focus is on documents only whereas the present method and system handles all file types. For legal purposes, it is important that the present method and system preserves the document as originally submitted without imposing the limitation of disallowing the user to retrieve the original document. The proposed system can demonstrate that the file is maintained in the original state, whereas fundamentally by changing the doc into read-only format, the file itself might be modified in the WO-A-2008/070335 system as described.

Yet further, an issue arises with respect to the encryption and decryption of stored uploaded documents, as well as coding errors compromising access controls, as the single private encryption key must be known to each server on a system to allow it to encrypt and decrypt content. If unauthorized users, including hackers and/or staff gain access to this key, content as well as the user identity associated may be compromised.

A related approach is to encrypt uploaded content using encryption keys that are generated on per originator and/or per item.

In this case, the generated keys must be stored such that they are available to decrypt the content when it is downloaded. The server software must also have functionality to access this storage and select the right key to decrypt a particular content item. An unauthorized user gaining access to the system or copying one or more servers would hence be able to track this functionality, and reverse engineer the appropriate key for a particular data file.

Yet further, in any of the above set-ups, data owner and/or permitted originator and/or user must have suitable software installed to handle encryption/decryption or password protection on the device used to access the content, thereby potentially excluding access from e.g. mobile devices. As a result, the server simply acts as an online store of uploaded encrypted data, and does not play a role in the protection of the data files, or the originator identity.

Accordingly, it would be highly desirable if a method and system were available that do not have the shortcomings of encrypted systems, while still offering the possibility to employ a public/private key architecture.

It would also be highly desirable if there was a secure data repository employing such technology for the securization and/or verification of stored data files.

The foregoing discussion is presented solely to provide a better understanding of the nature of the problems confronting the art and should not be construed in any way as an admission as to prior art nor should the citation of any reference herein be construed as an admission that such reference constitutes “prior art” to the instant application.

### SUMMARY OF THE INVENTION

In first aspect, the present invention relates to a computer implemented method and system for identifying and linking a data originator and a data file or data batch originating from the originator through one or more data source systems, comprising:

(a) storing the data file on a permanent basis for subsequent verification purposes; verifying the identity of the data file originator through originator-specific information from the data source system; and

(b) generating unique data entries associated with the originator identity, the file identity and/or a file verification cryptographic digest, and a unique originator signature, and storing the data entries and signature in a Relay Access Table (RAT), and

(c) generating the public and private keys associated with both the data file and the originator and storing them in the RAT, and

(d) generating a certificate for verification of the data file that contains a digital signature, as well as a file cryptographic digest and metadata retrieved from the Key Depot and associated with filing conditions.

(e) entries of RAT are themselves individually encrypted or otherwise protected (e.g., by being strictly accessible from a certain location or through the use of certain dedicated hardware components), thereby increasing the aforementioned additional protection mechanisms conferred by the use of RAT.

In a further embodiment of the computer implemented method of the current invention, the Relay Access Table of step (b) further generates a data set comprising the session parameters, including a timestamp, IP address of the computer system used.

Another embodiment of the current computer implemented method further includes the steps of:

(i) associating the originator-specific public/private key information to the data file; and

(ii) assigning a timestamp to the data file and the associated originator-specific information to generate a secure data file; and

(iii) storing the secure data file in a secure repository memory module such that the non-alterability and the validity of the secure data file is ensured.

The computer implemented method of the current invention in yet another embodiment may further include encrypting the data file, and removing the unencrypted file from data storage.

An additional embodiment of the inventive computer implemented method involves generating a process log allowing the reconstruction of steps (a) to (d) of the method, and securely associating the process log with the data evidence block. In a further variation of the particular embodiment, the process authentication code may be embedded in the secure data file, thereby associating the process log and the data evidence block.

In another embodiment of the computer implemented method of the current invention, the secure repository memory module may be a write-once read-many storage medium.

The current invention also relates to a system for creating a personalized data repository for data batches obtained from one or more data source systems securely associated with an originator, the content of the data batch and the time of receipt. The system involves A) an originator interface agent, B) a Relay Access Table (RAT), and C) a secure repository memory module. In the system, the originator interface agent may be operable to verify the identity of an originator through originator-specific information from the data source system, and to receive a data file from the data source system. The Relay Access Table (RAT) may be operable to generate unique data entries associated with the originator identity, the file identity and/or a file verification cryptographic digest, and a unique digital signature associated with the data entries, and further generates a public/private key pair associated with the data file and the originator, and stores the data entries and signature in the Relay Access Table (RAT). Lastly, the secure repository memory module may be operable to store the authenticated secure data file and associated originator data entries.

In yet a further aspect, the subject invention relates to a system for the creation of a secure data-storage repository, further referred to as a data repository, which makes use of the Relay Access Table (RAT) for the securization, verification and certification of the data files and the association with a data originator, or authorized user. Such architecture makes it impossible to compromise the public and/or private keys via reverse engineering and eliminates digital collisions, including deliberate attacks seeking to induce such collisions.

The present system may be implemented to afford certain legal benefits. Maintaining digital materials in their original state for potential subsequent submission as evidence before a court or mediating body in cases where that material is deemed to be legally significant by a ruling authority. US and other Courts require that evidence must be authenticated as original as a prerequisite for admissibility (see Federal Rules of Evidence rule 901). The present system can provide such assurances of data originality by maintaining materials in a secure non-edit, non-delete environment.

Further, the present system may be implemented to prevent data spoliation and data manipulation. Data may be said to be manipulated if a file is edited, modified, or if it is stored in an environment where malware is present; if data is deleted, or removed, or if any metadata is actively appended to a file by modifying file characteristics in any way. The present systems removes the threat of data manipulation which may cause any material considered as evidence to be perceived as compromised or inadmissible.

The present system improves the strength of evidence due to the strength of its design ensuring strong chain of custody recording. At the time of file submission, both session metadata and IP/physical location metadata are associated via the RAT table to ensure that the origination environment is observed by the system. Then, until retrieval of materials for submission as evidence, data is stored in a non-edit, non-delete environment. The document is successfully delivered to Court or the mediating body when the verification process is invoked by the ruling authority or representative thereby ensuring the file has been continuously maintained in its original state.

### BRIEF DESCRIPTION OF THE FIGURES

These and further features can be gathered from the claims, description and drawings and the individual features, both alone and in the form of sub-combinations, can be realized in an embodiment of the invention and in other fields and can represent advantageous, independently protectable constructions for which protection is hereby claimed. Embodiments of the invention are described in greater detail hereinafter relative to the drawings, wherein:

FIG. 1 discloses a schematic overview of an embodiment of the method for the loading of a data file by an originator onto the repository.

FIG. 2 discloses a schematic overview of an embodiment of the method executed by the repository system attributing public/private keys to a data file and originator, and to issue a certificate and file validation link that can be downloaded/accessed by the user.

FIG. 3 discloses a schematic overview of an embodiment of the method for defining the RAT entries.

FIG. 4 discloses a schematic overview of an embodiment of the method for verification of the validity of file by originator.

FIG. 5 discloses a schematic overview of an embodiment of the method for generation of the public and private keys.

### DETAILED DESCRIPTION OF THE INVENTION

While the present invention is susceptible of embodiment in many different forms, there are shown in the drawings and will be described herein in detail specific examples and embodiments thereof, with the understanding that the present disclosure is to be considered as an exemplification of the principles of the invention and is not intended to limit the invention to the specific examples and embodiments illustrated.

The present process proposes an alternative to existing PKI, and does not, or not exclusively rely on encryption.

### DEFINITIONS

Reverse engineering is the process of discovering the technological principles of an object or system through analysis of its structure, function, and operation.

A public key is a value provided by some designated authority as an encryption key that, combined with a private key derived from the public key, can be used to effectively encrypt messages and digital signatures.

The use of combined public and private keys is known as asymmetric cryptography. A system for using public keys is called a public key infrastructure (PKI).

The hash value of a cryptographic hash function is called the cryptographic digest or simply digest.

A cryptographic hash function is a hash function that takes an arbitrary block of data and returns a fixed-size bit string, the cryptographic hash value, such that any (accidental or intentional) change to the data will (with very high probability) change the hash value.

Collision is a situation that occurs when two distinct pieces of data have the same hash value or cryptographic digest.

Originator signature or digital signature is a public key cryptographic digest, associated with the data entry.

Relay Access Table (RAT) is an encrypted or otherwise protected data structure, associating the data file with its originator via PKI.

Certificate of Authentication is an electronic logical object which corresponds to the respective RAT entry, containing a certificate number (public key cryptographic digest), file cryptographic digest, date/time sets of the file upload and certificate generation, uploader's full name, uploader's IP address, uploader's ISP name, digital file validation link.

Key Depot is an electronic logical structure, which is an embodiment of digital file metadata storage.

Originator, user. Originator depositings data into the system; whereas user comprises any other user of the system, including for instance a third party with whom a file with a corresponding verification certificate has been shared.

In the present process, user and/or originator do not receive a private or public key, but only a public key cryptographic digest, and therefore cannot compromise the security by using a key in a weak cryptographic context, as present in personal computers or mobile devices. Even in the case of using an individual compromised system, no access will be given to the hacker or abuser of the compromised system. Additionally, as the user and/or originator ultimately has no visible access to any key, but only the public key cryptographic digest, this digest process provides an additional encryption layer that obscures the user and/or originator further from the complications of the internal PKI, including the difficulties of maintaining very lengthy keys, as represented generally by character strings that may fill multiple pages.

Furthermore, since the process is exclusively driven by the system, and whereas user and/or originator only receives a public key cryptographic digest, no specific software at the user's and/or originator's computer is in principle required, therefore making the need for firmware updates obsolete.

Existing electronic cryptographic signature algorithms are typically based on hash functions, where collisions are possible. A further approach involves a symmetrical scheme involving a trusted 3rd party certificate authority. Herein the key management is complex in large networks, and object metadata is typically not taken into account. Yet a further approach involves an asymmetric scheme using a private and public key. Herein a user may compromise the private key, which may be reversed-engineered from a weak application. Also, typically, the object metadata is also not taken into account.

With the use of a RAT according to the present invention, there is no need to distribute the public keys separately and use separate software to authenticate files; only the file and file certificate is needed to authenticate a file; the objects metadata is preferably taken into account; while reverse engineering, using the file cryptographic digest, is not possible. The present method specifically may be employed to protect values or data files from reverse engineering as the addresses/values being relayed bear no cryptographic relationship to one another.

The present method preferably follows a workflow as set out above. It defines the RAT, and thus sets up a relational database; it starts collecting metadata, defines associations, and finally carries out the retention and verification as required.

The “digital signature” herein refers to a string of characters associated with a specific originator's identity and specific data file, enabling signature and authentication of records and files. An example of a digital signature is “42057EA68B4XDGUI5948690DFSFVDGS4F8SDRXFDFBEFSD5245680959 48690FDJFGETIUV984958TFKJ42KGHRNGJF984598GKJIKGHIHLN8W8R7 8YVD8CEC8B55DA526CBA42D719642”.

The method and system preferably combines cryptographic digest with the keys to connect specific messages, user's and/or originator's identity, session parameters, including timestamp and the IP address of the computer system being used, and can issue a certificate that a third party may use to verify the file and the metadata.

Further, the unique originator-specific signature, i.e. the private key, is not issued to the originator who can therefore not compromise it and instead will use the system for every transaction where the signature is involved. The private key is generated and retained by the system, without being made visible or accessible to the originator or end user, whose ability to compromise its security are thus restricted.

The proposed method and system is thus continually in the middle between originator and the repository system, as a “trusted third party”, whereas existing alternatives that do not impose this limitation, instead rely on the originator to ensure safekeeping of their string, therefore if the originator loses control of it other parties may “sign” on their behalf.

The present method preferably sets up at least two different databases, one at the public side containing the originator data to be matched, and one at the private side containing the identifiers and signatures. The method also defines the domain rules, and then links the databases through a RAT, whereby any entry or group of entries a first database correspond a unique entry in the RAT linking the first entry or entry group to a corresponding entry or group of entries in the second data base.

In the present process, the verification of the identity of the data file originator is advantageously done through originator-specific information from the data source system; including software and hardware data, the data such as the ISP, the IP address of the computer used to access system, two-factor authentication, tokens, smartcards, codes issued in print form or by message, or any other means that allow to verify the identity of the originator.

In the present method, each originator and data file is assigned a unique private/public key pair. The uploaded data files, the originator's identity and other data file relevant entries, such as irreversible cryptographic digest or other types of one-way encryption of it as well as the unique private/public key pair are stored in the Relay Access Table (RAT). In the method according to the subject invention, the RAT serves as the central database for PKI utilities, namely to issue and verify certificates; to verify the identity of users requesting information; and it serves as the link to the central secure signature registry as it stores and indexes keys, as will be set out below.

The data originator then may submit data files to be stored and verified, e.g., to upload to the system. Any data file may be employed that is suitable for storage and verification, including, but not limited to a binary file, a text file, an image, a video file, an audio file or other data. The files are then linked to a unique data entry, which associates the file with the originator identity, the file identity and/or a file verification cryptographic digest, and a unique originator signature associated with the data entries, and is stored in the Relay Access Table (RAT).

The term “Relay Access Table” herein refers to a data structure, the embodiment of which can be a set of records, which represent relationships, as in a database. Some or all elements of a RAT system may include physical elements including hardware components, e.g. the table may be contained on a dedicated chip, or input from physical tokens may be supplied to identify originators on the basis of pre-existing association between tokens and originators. Some rules may include there is a private key corresponding uniquely to certain public key, and to an object, such as a data file or another digital record, for example such as email.

The records comprising a Relay Access Table contain a key relationship governed by a PKI, as well as originator ID (user_ref), data file ID (object_ref), and a record ID, as for instance illustrate in Table 1:

TABLE 1
Sample Relay Access Table
Relay Access Table

ID (PK)
user_ref
object_ref
public_key
public_key_digest
private_key
rat_datetime

Any record in the Relay Access Table is unique, and relates to a single corresponding object. While by definition there can be no two identical Relay Access Table entries, the relationship within the table follow consistent relational parameters, including a PKI that applies to all records within the table.

In the subject system and method, the system generates a public/private key pair associated with the data file and the originator and stores them in the RAT. The RAT table enables a system architecture that is designed to cryptographically protect and simplify usage of a PKI. The present system serves as a cryptographic shell that protects the PKI while greatly easing the originator burden with respect to key maintenance.

The present system is built to house a conventional PKI, thereby allowing for the implementation of Information standards such as FIPS-140 (Federal Information Standard for Cryptography modules). Within the present system, the PKI may therefore be certified as FIPS-compliant, or compliant to some other commonly accepted cryptographic standards, as applicable, yet provide an even greater level of security than a stand-alone PKI system, by internally managing the keys required by the PKI for the originator via the RAT. After authenticating a digital asset (data, file, email, etc.) originator may request generation of a Certificate of Authentication, at which point originator is issued a public key cryptographic digest, but the public and private key structure isn't exposed either to the user or to the originator, thereby eliminating the possibility of reverse engineering with which standard PKI systems must constantly contend.

The public/private key pair work together such that neither public key nor private key can be publicly known or distributed, and remains publicly inaccessible. Only an authorized access to the Relay Access Table would allow linking the public key to a private key, and further allowing to find and access to the data file. Furthermore, whereas the instance of successful hacking required to access the RAT record would only compromise those records and not give the attackers the ability to create new records on behalf of the originator through their own systems, an attack carried out at the same degree of hacking if successfully compromised the private key in the existing systems would effectively give the attackers the ability to sign on behalf of the originator.

Generally, the public and/or private key may be generated cryptographically using some predetermined set of rules, which is consistent within the domain.

The system and method further preferably generates a certificate for verification of the data file and filing conditions, which may allow third parties to verify the status of the data file, and the fact that is has not been changed or corrupted. The preferably digital certificate is an electronic document that uses a digital signature to bind a public key with an identity information such as the name of a person or an organization, their address, and so forth; while the file signature is a data set used to identify or verify the content of a file.

Other processes depend on these values for verification of the stored data. The structure of the table typically remains static in that certain values are matched to certain other values consistently, however the values themselves may change.

The Relay Access Table according to the invention forms a component that bridges the PKI. Preferably, all records within a Relay Access Table structure obey the same rules, and advantageously, all record attributes within the Relay Access Table share the following characteristics, namely that the RAT creates a structure for subsequent verification of an object, and thereby enables the verification of a stored object.

At any given moment, originator should to be able to identify the private key, which corresponds uniquely to a certain public key cryptographic digest and associated object, such as a data file for storage, and associated with a specific originator. There is only one record in RAT per object corresponding to a specific originator association. The term “originator” herein typically means originator that has uploaded a file, but may also include users that are authorized by the originator.

### DETAILED DESCRIPTION OF THE FIGURES

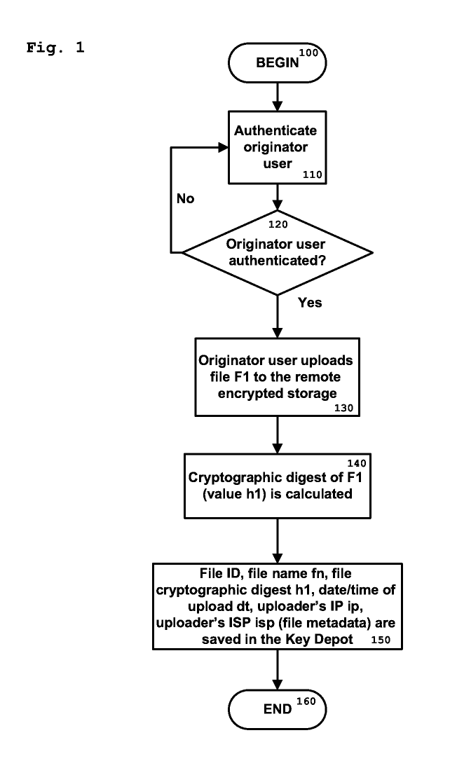

FIG. 1 discloses the process of originator authentication (110-120) uploading (130), the file by to the Certificate Authority-managed application. File upload triggers file digest calculation (140), metadata store in the Key Depot (150).

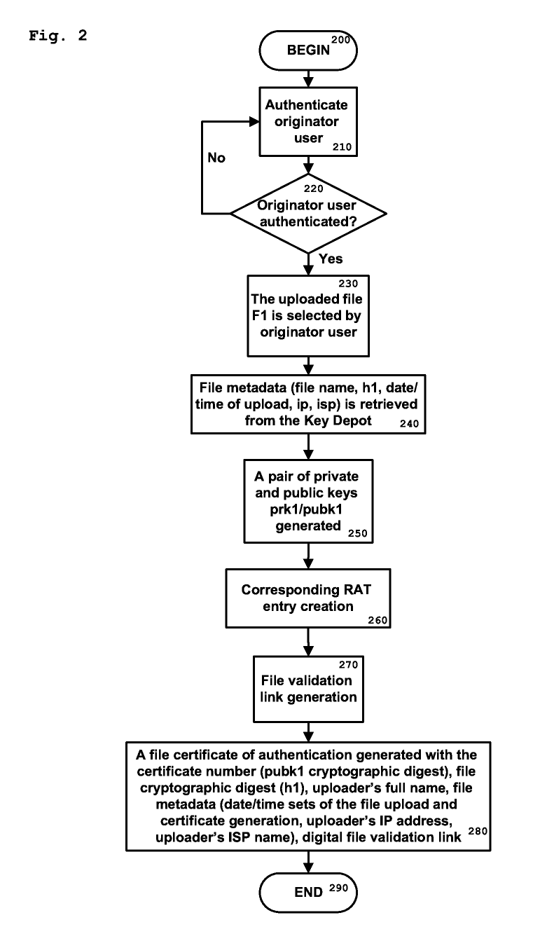

FIG. 2 discloses the process of originator authentication (210-220) selecting (230) the file to initiate digital signature (250)-(280) and the triggered digital certificate generation (290). Digital signature incorporates the file's metadata from the Key Depot (240) upon creation.

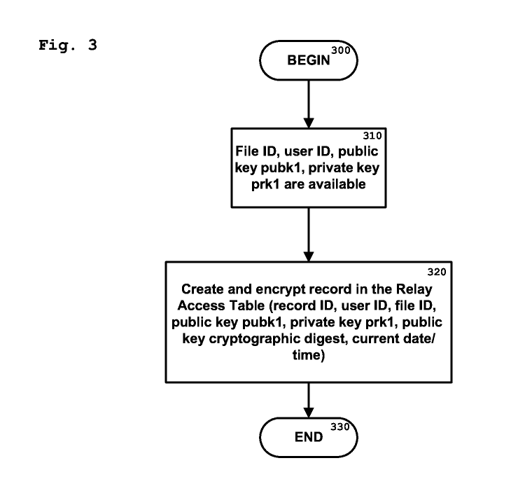

FIG. 3 discloses the sub-process indicated in FIG. 2 (270), File signature creation. FIG. 3 discloses creating the RAT entry for a file. The file reference, originator user reference and both public and private key references are available (310). Relay Access Table entry (incorporates the file reference, originator user reference, public key, private key, public key cryptographic digest and date/time) is created (320).

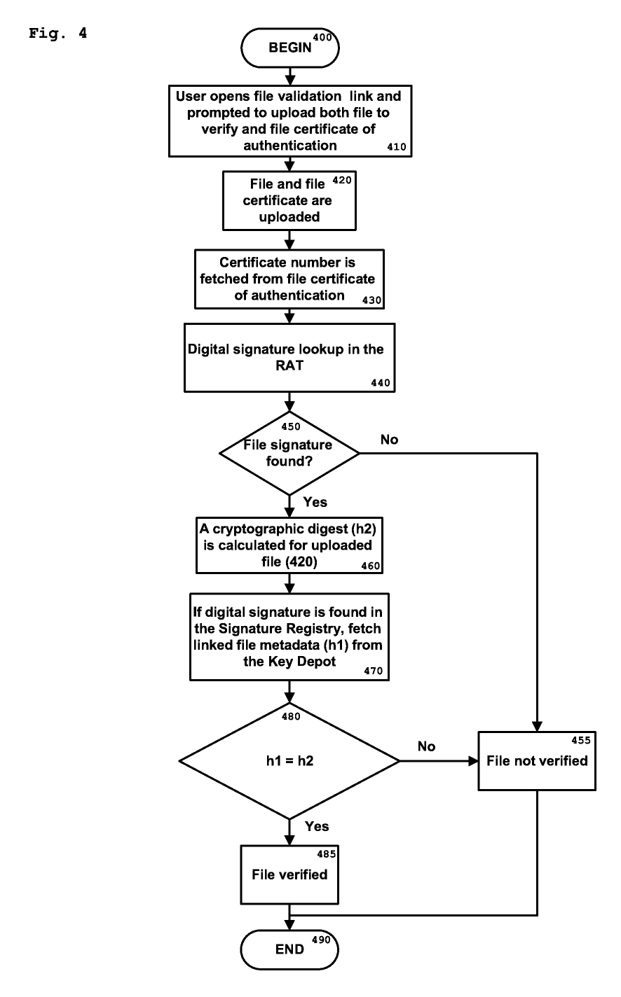

FIG. 4 discloses the file verification process. The previously uploaded (see FIGS. 1-3) file must be digitally signed with the trusted Certificate Authority (CA) and file certificate must be available. User navigates to the address referenced by the validation link, uploads the file and the file certificate (410), (420). Based on the file metadata fetched from the file certificate (430), the public key cryptographic digest (search key—public key cryptographic digest, retrieved from the file certificate of authentication) is looked up in the RAT (440), (450). In case the entry is not found, the file counts as not verified (455). If the RAT entry was found, the uploaded file cryptographic digest is calculated (460) and the previously uploaded file metadata is fetched from the Key Depot (470). The file digest, public key cryptographic digest from the Key Depot are compared respectively to the uploaded file's digest and public key cryptographic digest (480). In case both pairs match, the file counts as verified (485), or else the file is not verified (455).

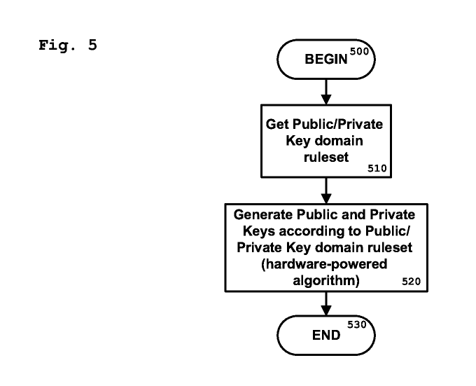

FIG. 5 discloses the public/private key pair generation procedure. The public key/private key domain rule set must be available (510). The public/private key pair is generated according to public/private key domain rule set (520), powered by the hardware-based algorithm.

One embodiment of the present invention relates to an integrated data repository, as opposed to merely retention of hash strings and keys, which is more of a one-stop-shop for the originator. Typically, the identification of the originator user according to the subject method may be employed as key component for a process that involves the data deposition in the repository and also the authentication. The system according to the present invention thus also preferably relates to a personal data repository, i.e. a system for a single originator to easily distribute verified content, as opposed to the existing systems where keys are unwieldy.

The repository may be preferably employed to document through a variety of means a variety of self-documentation methods, including but not limited to, e-mails, text messages from mobile handsets, specially generated text messages through a form-like interface on a personal computer terminal, either via a web application interface or that of a specialized application, voice-mail messages, fax messages, video and photographic materials created through webcams as well as cell phone cameras, smart glasses and/or contact lenses, wearable computers, tablets, smartphones, as well as embedded and/or implanted systems running firmware or full-scale operating systems and the like, both connected to networks in real time as well as transmitting in burst mode asynchronously, screenshots, dynamically generated website metadata, such as social-network API, and other forms of capturing otherwise non-static and thus transient and/or ephemeral content.

The repository may advantageously be used to carry out an association between a client and a legal representative of the client, possibly through a directory of lawyers, or alternatively an existing representative. The system is configured such that it allows for the application of the rules required to attain attorney-client privilege, e.g., confidentiality and security. In this case, a legal representative and a client are issued unique identifiers, whereby the representative becomes an authorized used for the specific purpose. The relationship may connect one or more legal representatives, with one or more clients, as for instance in the case of a class action suit, a school board, or labor unions. Herein, the system advantageously can support the collation of evidence, and even help with case management.

A benefit of the present system is that data files uploaded and stored may be retained exactly as originally signed/hashed, thereby minimizing risk of loss or inadvertent corruption by originator and/or user alteration or encryption and coding errors, which may corrupt the document, or compromise the usability as legal evidence. The embedded metadata may also be further extracted, allowing for further evidentiary reach into the past via eDiscovery and certain forms of forensic analysis.

The ongoing accumulation of secured data files and entries comprising various forms of evidence preferably may support future legal action or claims.

Other forms may include taking notes on paper, dating them possibly, and then photographing them and transmitting to the repository with option on graphological analysis in the future. Additionally, voice accounts of events, together with voice stress analysis, (web) camera recordings and other methods of detecting the users' or others' state of mind may be part of the data to be collated.

Typically, a user may create voicemails and notes as audio and/or video files of themselves, or document pertinent events on a webcam or a video made with a mobile phone or another suitable device, to support specific accounts of events, which upon storage and time-stamping may also serve as depositions, affidavits, witness accounts and/or other legally relevant documents.

Preferably, the data files that are submitted by originator for storage in the repository may be geo-tagged. This may be conveniently achieved by adding GPS data by the sending device to the data block where applicable. For instance, claims of being bullied workplace would likely benefit from having a set of reproducible workplace coordinates attached to them. Cross-checks with presently available online services like street view depictions of certain areas may be implemented to corroborate user accounts of specific events in the legal context, especially where geo-tagged media pertaining to the same time window has been generated by other individuals and made available online through indexed services. For instance, an individual claim that there was a car accident at an intersection at a certain point in time may be corroborated or proven unlikely by third party photographs or films made at the same intersection at the same time or shortly thereafter.

The method preferably also offers an option to send accounts of events to others for comment and corroboration. For instance, originator may document a life event, and then communicate, preferably by e-mail or other means of information exchange, such as instant messaging, the life event data to other people with a request to add their comments. Any comments received may advantageously be included in the data repository without altering the original documents as previously authenticated. Such comments may be stored in some cases as new documents, subject to their own respective authentication.

By documenting herein is understood the accounts of an individual originator of various life events, including abusive encounters, e.g. aggression, or other events affecting the originator. These submissions are time-stamped, and authenticated upon submission, and recorded as close to the initial moment of the incident as possible, to be advantageous for subsequent judicial and/or administrative proceedings.

Preferably, the data repository will format the accumulated evidence in such way that it can be used directly for court proceedings, e.g., by formatting the data according to a preset format as required for submissions.

The term “evidence” herein means any means of proof that can validate facts and can be used as testimony or to enhance testimony in a court or formal hearings or proceedings, including mediation or arbitration.

A primary advantage of the subject method is to give the accumulating evidence a structure prior to or in early phases of a legal dispute, preferably prior to the opening of legal proceedings, where ordinarily a very limited record, if any, would have been retained of the life events of the originator in the phases leading up to the legally significant escalation, such as early-phase data being of importance in diagnosing the drivers of the situation as well as scope of legal liability and possibly other parties affected, as in the case of mistreatment of one employee resulting in a class action suit costing the employer more.

This advantageously may give an individual originator an option to document life events in an appropriate way, allowing for the structured retention of key legal information to the future advantage of the client.

Other circumstances where self-documentation according to the subject invention may be useful include for instance the need to prove that an idea occurred to someone first, the determination of copyrights, for instance by an author documenting a manuscript by the subject method, and circumstances where non-written agreements could be supported by creating an evidence repository of the agreement, e.g., by film or sound recording according to the invention. An example may be that verbal agreements under many jurisdictions, such as Dutch, French or US law are deemed binding on the parties, however compelling proof for the content of such an agreement is often difficult to procure, often leading to judgments based on an equitable interpretation of situation in hindsight rather than the exact wording of the agreement at the time of acceptance.

As indicated above, the system of the present invention generally may comprise a memory storing a data repository (or database) and a processor, such as a processor included within a mainframe computer of system or within either (or both) a database management server or an application server.

The processor may be programmed to perform the linking methodology of the present invention, generally as part of more general search and match capability, for inquiry data or for reporter data. As a consequence, the system and method of the present invention may be embodied as software which provides such programming.

More generally, the system, methods and programs of the present invention may be embodied in any number of forms, such as within any type of computer, within a workstation, within an application server such as an application server preferably within a database management server, within a computer network, within an adaptive computing device, or within any other form of computing or other system used to create or contain source code. Such source code further may be compiled into some form of instructions or object code (including assembly language instructions or configuration information). The software or source code of the present invention may be embodied as any type of source code, such as SQL and its variations (e.g., SQL 99 or proprietary versions of SQL), C, C++, Java, or any other type of programming language which performs the functionality discussed above. As a consequence, a “construct” or “program construct”, as used herein, means and refers to any programming language, of any kind, with any syntax or signatures, which provides or can be interpreted to provide the associated functionality or methodology (when instantiated or loaded into a server or other computing device).

The software or other source code of the present invention and any resulting bit file (object code or configuration bit sequence) may be embodied within any tangible storage medium, such as within a memory or storage device for use by a computer, a workstation, any other machine-readable medium or form, or any other storage form or medium for use in a computing system. Such storage medium, memory or other storage devices may be any type of memory device, memory integrated circuit (“IC”), or memory portion of an integrated circuit (such as the resident memory within a processor IC), including without limitation RAM, FLASH, DRAM, SRAM, MRAM, FeRAM, ROM, EPROM or E2PROM, or any other type of memory, storage medium, or data storage apparatus or circuit, depending upon the selected embodiment. For example, without limitation, a tangible medium storing computer readable software, or other machine-readable medium, may include a floppy disk, a CDROM, a CD-RW, a magnetic hard drive, an optical drive, a quantum computing storage medium or device, a transmitted electromagnetic signal (e.g., used in internet downloading), or any other type of data storage apparatus or medium.

In summary, the present invention provides a method, system and software for associating a plurality of business records to a business entity of a plurality of business entities. An exemplary system embodiment comprises a memory storing or housing a data repository and a processor coupled to the data repository, such as a processor within a mainframe computer, an application server or a database management server. The data repository (memory) stores the plurality of business records and stores a plurality of business identifiers, wherein each business identifier of the plurality of business identifiers is unique. The processor is configured to associate a first business record, of the plurality of business records, with a first business identifier of the plurality of business identifiers; and to associate a second business record, of the plurality of business records, with a second business identifier of the plurality of business identifiers. This second association, of a second BID, is generally a consequence of the second business record not matching the first business record sufficiently. Subsequently, when the first business identifier and the second business identifier are determined to correspond to a singular business entity of the plurality of business entities, the processor is further configured to link the first business identifier and the second business identifier and to maintain the link of the first business identifier and the second business identifier in the data repository.

All references including patent applications and publications cited herein are incorporated by reference in their entirety and for all purposes to the same extent as if each individual publication or patent or patent application was specifically and individually indicated to be incorporated by reference in its entirety. Further, from the foregoing, it will be observed that numerous variations and modifications may be effected without departing from the spirit and scope of the novel concept of the invention. It is to be understood that no limitation with respect to specific methods and apparatus illustrated herein is intended or should be inferred. It is of course, intended to cover by the appended claims all such modifications as fall within the scope of the claims.

1. A computer implemented method for identifying and linking a data originator and a data file or data batch originating from the originator through one or more data source systems, comprising:
(a) storing the data file on a permanent basis for subsequent verification purposes; verifying the identity of the data file originator through originator-specific information from the data source system; and
(b) generating unique data entries associated with the originator identity, the file identity and/or a file verification cryptographic digest, and a unique originator signature, and storing the data entries and signature in a Relay Access Table (RAT),
(c) generating of the public and private keys associated with both the data file and the originator and storing them in the RAT, and
(d) generating a certificate for verification of the data file that contains a digital signature, as well as a file cryptographic digest and metadata retrieved from the Key Depot and associated with filing conditions.
(e) entries of RAT are themselves individually encrypted or otherwise protected (e.g., by being strictly accessible from a certain location or through the use of certain dedicated hardware components), thereby increasing the aforementioned additional protection mechanisms conferred by the use of RAT.

2. A computer implemented method according to claim 1, wherein in step (b) the Relay Access Table further generates a data set comprising the session parameters, including a timestamp, IP address of the computer system used.

3. A computer implemented method according to claim 1, comprising
(i) associating the originator-specific public/private key information to the data file; and
(ii) assigning a timestamp to the data file and the associated originator-specific information to generate a secure data file; and
(iii) storing the secure data file in a secure repository memory module such that the non-alterability and the validity of the secure data file is ensured.

4. A computer implemented method according to claim 1, further comprising encrypting the data file, and removing the unencrypted file from data storage.

5. A computer implemented method according to claim 1, further comprising generating a process log allowing the reconstruction of steps (a) to (d), and securely associating the process log with the data evidence block.

6. A computer implemented method according to claim 6, wherein the process authentication code is embedded in the secure data file, thereby associating the process log and the data evidence block.

7. A computer implemented method according to claim 1, wherein the secure repository memory module comprises a write-once read-many storage medium.

8. A system for creating a personalized data repository for data batches obtained from one or more data source systems securely associated with originator, the content of the data batch and the time of receipt, comprising:
A) an originator interface agent, and
B) a Relay Access Table (RAT), and
C) a secure repository memory module,
wherein the originator interface agent is operable to verify the identity of an originator through originator-specific information from the data source system, and to receive a data file from the data source system; wherein the Relay Access Table (RAT) is operable to generate unique data entries associated with the originator identity, the file identity and/or a file verification cryptographic digest, and a unique digital signature associated with the data entries, and further generates a public/private key pair associated with the data file and the originator, and stores the data entries and signature in the Relay Access Table (RAT); and wherein secure repository memory module is operable to store the authenticated secure data file and associated originator data entries.
